(19) United States
(12) Patent Application Publication
(10) Pub. No.: US 2025/0007305 A1
(43) Pub. Date: Jan. 2, 2025

(54) SOUND-BASED CHARGING DEVICE

(71) Applicant: Harold Jason, North Miami Beach, FL (US)

(72) Inventor: Harold Jason, North Miami Beach, FL (US)

(21) Appl. No.: 18/217,590

(22) Filed: Jul. 2, 2023

(51) Int. Cl. H02J 7/00; G06F 1/16; H02N 1/04

(52) U.S. Cl. CPC H02J 7/0045; G06F 1/1632; H02J 7/007; H02N 1/04

(57) ABSTRACT

A sound-based charging device provides for the ability to charge electronic devices such as mobile telephones via sound waves either by a sound producing base or general ambient sound source in an area. The device has a back surface and four (4) sides of conventional design. Various openings are provided for control devices, speakers, cameras, microphones and the like depending on the specific usage. A charging control switch is attached on the protective case. An electronics housing is attached on the rear surface of the protective case Finally, a charging plug is attached on the interior of the protective case, preferably on the lower sides such that it engages the charging port of the various electronic device inserted within the protective case.

### FIELD OF THE INVENTION

The present invention relates generally to electronic charging devices, and particularly to a sound-based charging device for charging electronic device.

### BACKGROUND

Mobile phone chargers have gone through a diverse evolution that has included cradles, plug-in cords and obscure connectors. Universal charger or common charger refers to various projects to standardize the connectors of power supplies, particularly for battery-powered devices. External batteries are most commonly stand-alone devices, which can be cabled to the phone's primary charging connector. Older devices generally use micro-USB connectors, while newer devices tend to use USB-C. Other types of chargers include external battery chargers, solar chargers, wireless chargers.

Solar cell phone chargers use solar panels to charge cell phone batteries. They can be used when no electricity supply is available—either mains or, for example, a vehicle battery—and are sometimes suggested as a way to charge phones without consuming mains electricity, unlike electrical cell phone chargers. Some can also be used as a conventional charger by plugging into an electrical outlet. Some chargers have an internal rechargeable battery which is charged in sunlight and then used to charge a phone; others charge the phone directly.

Solar cell phone chargers come in different shapes and configurations including folding (Goal Zero, Endless Sun Solar) and types that unfold like petals (Solio). They also come in the form of straps, with solar cells on the outer surface and a rechargeable battery inside. Solar cell technology limits the effectiveness and practicality of phone solar chargers for everyday use.

Solar chargers used to charge a phone directly, rather than by using an internal battery, can damage a phone if the output is not well-controlled, for example by supplying excessive voltage in bright sunlight. In less bright light, although there is electrical output it may be too low to support charging, it will not just charge slower.

Wireless chargers come in generally three types. There are charging pads that use tightly coupled electromagnetic inductive or non-radiative charging; charging bowls or through-surface type chargers that use loosely coupled or radiative electromagnetic resonant charging that can transmit a charge a few centimeters; and uncoupled radio frequency (RF) wireless charging that allows a trickle charging capability at distances of many feet.

All in all, wireless charging offers a mess-free, convenient method to charge your phone, earbuds, smartwatch and more. Although wireless charging provides a lot of benefits, there is one downside to a wireless charging accessory: It is not as efficient as wired charging or a fast-charging cable.

Distance plays a huge role, too. The further away your device's receiver is from the wireless charger's transmitter, the slower it will charge. Essentially, the magnetic field will struggle to transmit power to the device if it's not directly on top of the wireless charger.

Some charging devices can be integrated into cases, namely functional cases, which are designed to attach to, support, or otherwise hold a smartphone, or other technology are popular accessories. There are several different types of cases including shells, skins, pouches, and sleeves as well as many others. Some of the integrated charging devices within the cases are external batteries or a USB, Bluetooth, or Wi-Fi keyboard and touchpad.

Accordingly, and in light of the foregoing, it would be desirable to be able to charge a mobile device such as a smart phone or tablet as well as others using sound waves vs the current technologies available. The sound generated charging device would either use a sound producing base, or general ambient sound source from outside sounds such as machinery, natural sounds (wind, rain, etc.), music, etc. The sound wave charging device would be incorporated into a case for the device utilizing it. Sounds exist everywhere, making the device easily usable and eliminate the disadvantages seen with other charging devices.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the sound-based charging device 10, according to the preferred embodiment of the present invention;

FIG. 2 is a perspective view of the sound-based charging device 10, shown with an electronic device 50 being installed, according to the preferred embodiment of the present invention;

FIG. 3 is a sectional view of the sound-based charging device 10, as seen along a line I-I, as shown in FIG. 1, according to the preferred embodiment of the present invention;

FIG. 4 is a pictorial view of the sound-based charging device 10, according to the preferred embodiment of the present invention; and,

FIG. 5 is an electrical block diagram of the sound-based charging device 10, according to the preferred embodiment of the present invention.

### DESCRIPTIVE KEY

10 sound-based charging device
15 protective case
20 back surface
25 side
30 opening
35 charging control switch
40 electronics housing
45 charging plug
50 electronic device
55 first insertion path “a”
60 charging port
65 second insertion path
70 triboelectricity generator
75 power regulator circuit board
80 internal battery
85 base station
90 power cord
95 external power source
100 first sound waves
105 charging path
110 ambient sound source
115 second sound waves

### DESCRIPTION OF THE PREFERRED EMBODIMENTS

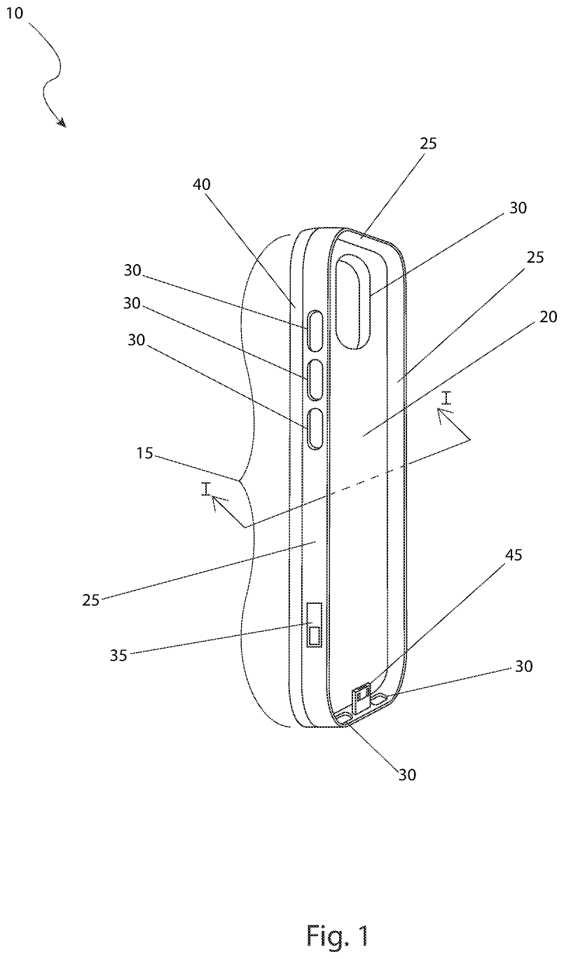

The best mode for carrying out the invention is presented in terms of its preferred embodiment, herein depicted within FIGS. 1 through 5. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### 1. Detailed Description of the Figures

Referring now to FIG. 1, a perspective view of the sound-based charging device 10, according to the preferred embodiment of the present invention is disclosed. The sound-based charging device (herein also described as the “device”) 10, provides for the ability to charge electronic devices 50 such as mobile telephones via sound waves 100, 115, either by a sound producing base, or general ambient sound source 110 in an area. The device 10 comprises a back surface 20 and four (4) sides 25 of conventional design. Various openings 30 are provided for control devices, speakers, cameras, microphones and the like depending on the specific usage. It is envisioned that the device 10 would be made in multiple models for all makes and models of electronic devices. A charging control switch 35 is provided on the protective case 15. Further detail on the usage of the charging control switch 35 will be provided herein below. An electronics housing 40 is provided on the rear surface of the protective case 15 and will also be described in further detail herein below. Finally, a charging plug 45 is provided on the interior of the protective case 15, preferably on the lower sides 25 such that it engages the charging port of the various electronic device inserted within the protective case 15. Further detail on the use of the charging plug 45 will be provided herein below.

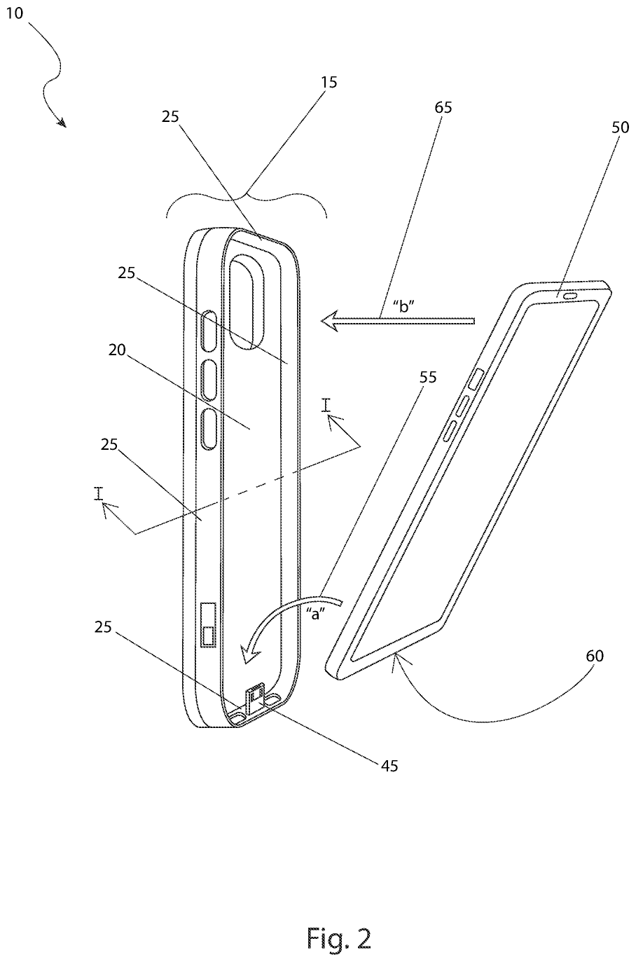

Referring next to FIG. 2, a perspective view of the device 10, shown with an electronic device 50 being installed, according to the preferred embodiment of the present invention is depicted. The electronic device 50 is depicted as a mobile telephone for illustrative purposes. However, it is noted that other types of personal electronic devices such as laptop computers, personal digital assistants (PDA's), portable gaming systems, headsets, earpieces, portable MP3 players, and the like could also be utilized. As such, the use of any specific type of electronic device 50 with the device 10 is not intended to be a limiting factor of the present invention. The electronic device 50 engages the protective case 15 along a first insertion path “a” 55 such that a charging port 60 on the electronic device 50 engages the charging plug 45, as travel along the charging port 60 is nearly completed, the remainder of the electronic device 50 is inserted into the cavity formed by the protective case 15 and the back surface 20 along a second insertion path 65, until the electronic device 50 is full inserted into the protective case 15. As such, the charging plug 45 is capable of charging the electronic device 50 as long as it is inserted into the protective case 15.

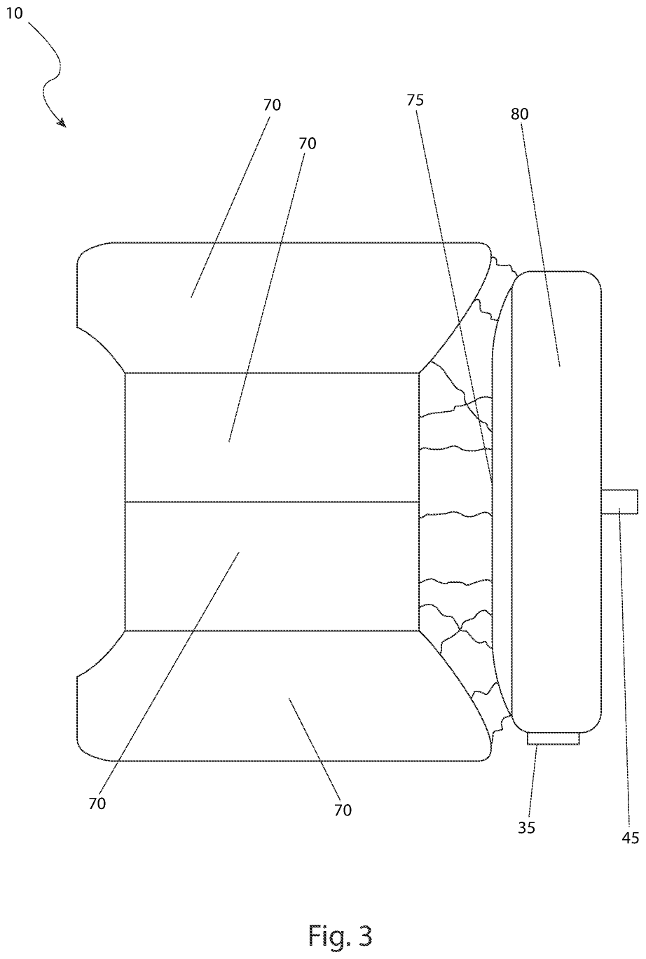

Referring now to FIG. 3, a sectional view of the device 10, as seen along a line I-I, as shown in FIG. 1, according to the preferred embodiment of the present invention is shown. Internal components of the electronics housing 40 (as shown in FIG. 1) include but are not limited to four (4) triboelectricity generators 70 which generate electric power when exposed to sound pressure waves in the twenty to twenty-four hertz (20-24 Hz.) range, below the range of human hearing. Operation of the triboelectricity generators 70 is well-known in the art. The triboelectricity generators 70 are connected in a parallel circuit arrangement to a power regulator circuit board 75 which regulates the power generated by the triboelectricity generators 70. The resultant power is then passed onto an internal battery 80 or the charging plug 45 via the charging control switch 35. It is noted that the internal battery 80 is used to store any excess charge from the triboelectricity generators 70 should the electronic device 50 be already fully charged. In such an instance, the internal battery 80 may then be used to charge the electronic device 50 at a later time when no sound is present.

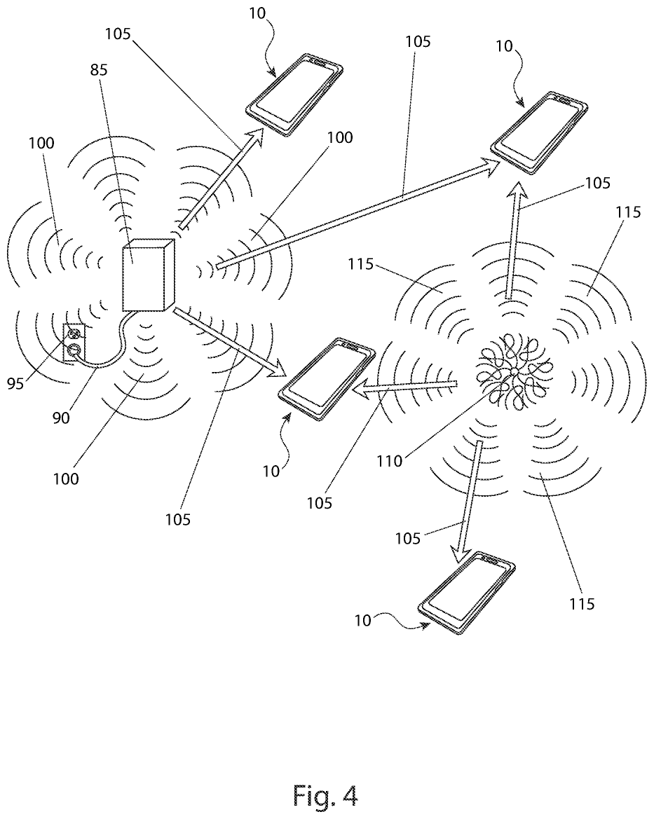

Referring next to FIG. 4, a pictorial view of the device 10, according to the preferred embodiment of the present invention is disclosed. The power to operate the device 10 is envisioned to come from two different sources. The first is a base station 85 that is connected via a power cord 90 to an external power source 95 such as an AC power receptacle. The base station 85 is a simple oscillating circuit and amplifier that produces first sound waves 100 in an omnidirectional pattern, in the twenty to twenty-four hertz (20-24 Hz.) range. These sound waves emanate outward where they form charging paths 105 with one (1) or more device 10, which then interact with the triboelectricity generators 70 (as shown in FIG. 3) to charge the electronic device 50 (as shown in FIG. 2) contained within the device 10. The second means of operating the device 10 is via an ambient sound source 110 which produces sound in the twenty to twenty-four hertz (20-24 Hz.) range. Such sound sources are envisioned to include machinery operation, naturally occurring sound (wind, thunder, and the like), conversation, music, and other similar means. The ambient sound source 110 will produce a second sound waves 115 which will then interact with the triboelectricity generators 70 to charge the electronic device 50 contained within the device 10. It is noted that multiple devices 10 can be charged by the external power source 95 and/or the ambient sound source 110 in a simultaneous manner.

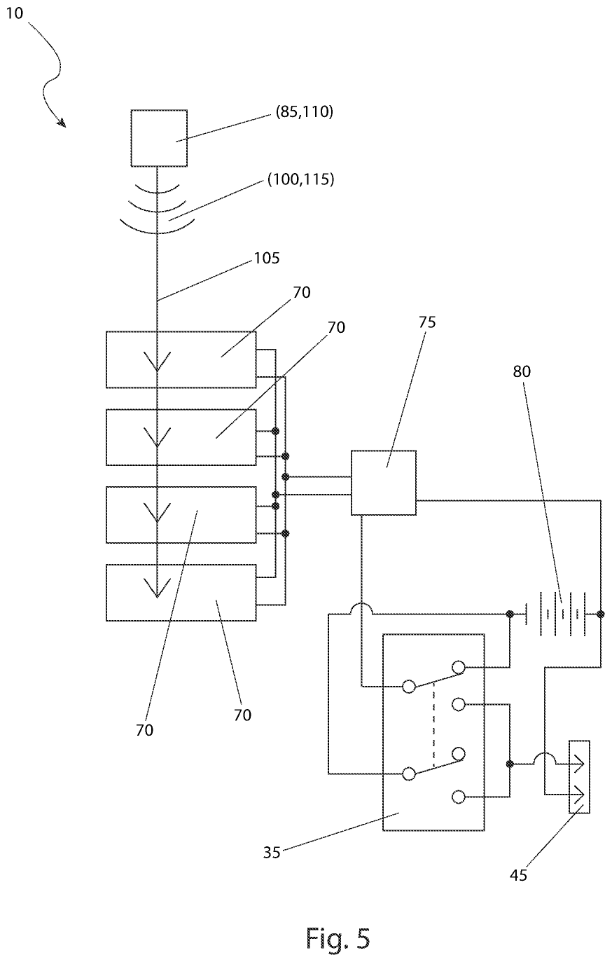

Referring to FIG. 5, an electrical block diagram of the device 10, according to the preferred embodiment of the present invention is depicted. The base station 85 or the ambient sound source 110 will produce a first sound waves 100 or second sound waves 115 respectively which forms charging paths 105 with the multiple triboelectricity generators 70 of a single device 10. The triboelectricity generators 70 are connected in a parallel manner to the power regulator circuit board 75. The negative output of the power regulator circuit board 75 is routed to the negative terminal of the internal battery 80 and the negative terminal of the charging plug 45. The positive terminal of the power regulator circuit board 75 is routed to the charging control switch 35 consisting of a double pole, double throw switch, which may charge the internal battery 80 in the upward position, or charge both the internal battery 80 and the charging plug 45 in the downward position. It is noted that the downward position connects the internal battery 80 to the charging plug 45 so that the charging plug 45 may charge the electronic device 50 (as shown in FIG. 2) should no sound be present.

### 2. Operation of the Preferred Embodiment

The preferred embodiment of the present invention can be utilized by the common user in a simple and effortless manner with little or no training. It is envisioned that the device 10 would be constructed in general accordance with FIG. 1 through FIG. 5. The user would procure the device 10 from conventional procurement channels such as electronic stores, cell phone retailers, discount stores, department stores, mail order and internet supply houses and the like. Special attention would be paid to the exact type of electronic device 50 to be used with the device 10 as multiple versions of the present invention are envisioned.

After procurement and prior to utilization, the device 10 would be prepared in the following manner: in the case of an electronic device 50 being a cellular phone, the charging port 60 would be engaged with the charging plug 45 along the first insertion path “a” 55; next, the electronic device 50 would be fully inserted into the protective case 15 along the second insertion path 65. Various other installation procedures, but similar in practice, would be followed for other types of electronic device 50 such as laptop computers, personal digital assistants (PDA's), portable gaming systems, headsets, earpieces, portable MP3 players, and the like. At this point in time, the device 10 is ready for utilization.

During utilization of the device 10, the following procedure would be initiated: in areas with adequate ambient sound source 110, the triboelectricity generators 70 will intercept such second sound waves 115 along a charging paths 105 and generate an electric voltage; the triboelectricity generators 70, connected in a parallel manner to the power regulator circuit board 75, generate an appropriate voltage for the internal battery 80 and the internal battery of the electronic device 50. In the case of a depleted internal battery of the electronic device 50, the charging control switch 35 is configured such that the internal battery 80 allows the charging plug 45 to charge the electronic device 50. In the case of a fully charged electronic device 50, the charging control switch 35 is positioned to charge the internal battery 80 of the device 10.

Should inadequate or no ambient sound source 110 be present, the base station 85 may be connected to an external power source 95 via the power cord 90 to generate first sound waves 100. The first sound waves 100 then work in an identical manner to the ambient sound source 110 to operate the device 10.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A sound-based charging device for charging electron devices, the sound-based charging device comprising:
a back surface;
four (4) sides;
one or more triboelectricity generators, the one or more generators coupled to a power regular circuit board, the generators are in a parallel configuration, the triboelectricity generators receiving a first sound wave or second sound wave from a source;
an internal battery;
a charging plug;
a negative output of the power regulator circuit board is routed to a negative terminal of the internal battery and to the negative terminal of the charging plug;
a positive terminal of the power regulator circuit board is routed to a charging control switch, the charging control switch having a double pole, double throw switch; and
wherein the triboelectricity generators are configured to convert the first sound wave or second sound wave of the source into electrical current.

2. The sound-based charging device according to claim 1, wherein the source is a base station.

3. The sound-based charging device according to claim 1, wherein the source is an ambient sound source.

4. The sound-based charging device according to claim 1, wherein the charging plug is removably coupled to an electronic device.

5. The sound-based charging device according to claim 4, wherein the electronic device is a cell phone.

6. The sound-based charging device according to claim 4, wherein the electronic device is a computer tablet.

7. The sound-based charging device according to claim 4, wherein the electronic device is a laptop computer.

8. The sound-based charging device according to claim 4, wherein the electronic device is a computer.

9. The sound-based charging device according to claim 1, wherein the sound base charging device has a protective case.

10. The sound-based charging device according to claim 9, wherein the sound-based charging device has a charging control switch, the charging control switch is coupled to the internal battery of the sound-based charging device.

11. The sound-based charging device according to claim 11, wherein the charging control switch is coupled to an outside of the protective case.

12. The sound-based charging device according to claim 11, wherein the charging control switch has a double pole, double throw switch, wherein the charging control switch is configured to charge the internal battery of the sound-based charging device in an upward position.

13. The sound-based charging device according to claim 11, wherein the charging control switch is configured to charge the internal battery of the sound-based charging device in an upward position, or charge both the internal battery and the charging plug in a downward position.

14. The sound-based charging device according to claim 11, wherein the charging control switch has a double pole, double throw switch, wherein the charging control switch is configured to charge both the internal battery of the sound-based charging device and the charging plug in the downward position.

15. The sound-based charging device according to claim 11, wherein when a depleted internal battery of the electronic device, the charging control switch is configured to allow the charging plug to charge an internal battery of the electronic device.

16. The sound-based charging device according to claim 11, wherein when a fully charged electronic device 50, the charging control switch is configured to charge an internal battery of the electronic device.
